(19) United States
(12) Patent Application Publication
(10) Pub. No.: US 2004/0029076 A1
(43) Pub. Date: Feb. 12, 2004

(54) Denture attachment system and method

(76) Inventor: Duane Nowack,, Ramona, CA (US)

Correspondence Address: Duane Nowack D.D.S., 1721 Main St #108, Ramona, CA, 92065, US

(21) Appl. No.: 10/445,755

(22) Filed: May 27, 2003

Related U.S. Application Data
(60) Provisional application No. 60/387,121, filed on Jun. 7, 2002.

(51) Int. Cl. A61C 13/24

(52) U.S. Cl. 433/187

(57) ABSTRACT

A denture plate having hemispherical suction holes that correspond to the soft tissue areas on the roof of the mouth for increasing adhesion between the denture plate and the roof of the mouth. The increase in adhesion allows for removal of the front portion of a U-shaped channel that is typically used to create adhesion between the denture plate and the upper portion of the mouth. The increase in retention allows for the fabrication of a roofless or frontless upper denture with adequate retention for patient comfort and increased esthetics.

This application is based on the Provisional Patent Application entitled Denture Attachment System and Method filed on Jun. 7, 2002 with serial No. 60/387,121 incorporated herein by this reference.

### FIELD OF THE INVENTION

The present invention relates to improved system and method of attaching dentures to the mouth of a patient.

### BACKGROUND OF THE INVENTION

On many patients the front portion of the full denture channel is visible when the patient smiles. It would be an advantage to eliminate the front portion, or labial flange, so that the patient would have a more natural looking smile. However, elimination of the labial flange means that there is less surface area for the denture to adhere to the gum. With less adhesive surface area, the denture is more likely to come loose during use. It would be an advantage to increase the adhesion of the inside surface of denture to the roof of the mouth so that the labial flange can be eliminated while at the same time maintaining sufficient adhesion to the gum.

### SUMMERY OF THE INVENTION

The present invention involves making a series of hemisphere shaped holes in a specific area of the top portion of the denture that coincides with the soft tissue area on the roof of the mouth. The soft tissue area on the roof of the mouth will conform to the top edges of the hemisphere and create areas of increased adhesion especially with the use of dental adhesive. The location of the hemisphere cutouts is tailored to each individual patients. Some patients have more soft tissue area on the roof of their mouth than other patients and the location of the soft tissue area can vary between patients.

In another aspect of the present invention, existing dentures can be retrofitted with a portion of hemispherical holes. In this instance, a portion of denture surface area corresponding to the soft tissue area of the patient is removed by using a tool that can cut out the surface area of denture without cutting all the way through the denture. Then, a corresponding section of hemisphere shaped holes is attached by adhesive to the area that was cut out. The labial flange can then be removed to give the denture a more natural appearance. Thus, existing dentures can be retrofitted and improved.

An object of the present invention is to provide denture with improved adhesion to the inside surface of the mouth.

It is another object of the invention to provide a denture with improved adhesion to the soft tissue on the roof of the mouth so that the front portion of denture can be removed to give a more natural appearance

It is a further object of the invention to provide a system for retrofitting existing dentures to add adhesive hemispheres to the portion of denture that corresponds to be soft tissue area on the roof of the mouth.

It is another object of the invention to provide a system for fabricating a roofless denture with adequate retention allowing the patient to feel consistency of food on a natural roof.

It is a further object of the invention to provide a roofless and/or frontless denture with adequate retention for a more natural appearance and allowing the patient to feel consistency of food on a natural roof.

The novel features of the present invention are set forth with particularity in the appended claims. The invention will best be understood from the following description when read in conjunction with the accompanying drawings in which:

### BRIEF DESCRIPTION OF THE DRAWINGS

FIG. 1 is a picture showing denture designed to fit in the upper portion of the mouth showing the location of he hemispherical suction holes;

FIG. 2 is a front view of the denture that provide additional adhesion with the soft tissue of the upper portion of the mouth and shows the front portion, or labial flange that can be removed;

FIG. 3 is a top view drawing of the hemispherical suction holes;

FIGS. 4 and 5 are a side view of the section holes shown in FIGS. 1, 2 and 3; and

FIG. 6 is a view of the roof of the mouth showing the potential locations of the soft tissue areas that would contact the suction holes.

FIG. 7 is a picture of the roofless denture attached to a model of the roof of the mouth.

### DETAILED DESCRIPTION OF THE PREFERRED EMBODIMENT

The present invention involves making hemispherical suction holes on the portion of the denture that corresponds to the soft tissue areas that are found on the roof of the mouth. The edges of the section holes slightly penetrate the soft tissue areas on the roof of the mouth to create adhesion. When the section holes are used in conjunction with a denture adhesive, sufficient adhesion is created between the denture and the roof of the mouth so that the front portion of indenture can be removed, or never made, giving the denture a more natural appearance when a person smiles.

FIG. 1 shows the top surface area of denture 10 having suction holes 20 located to correspond to the soft tissue area on the roof of the mouth. A denture adhesive is spread over the holes 20 and on surface area 22 to facilitate affixing the denture to the roof of the mouth.

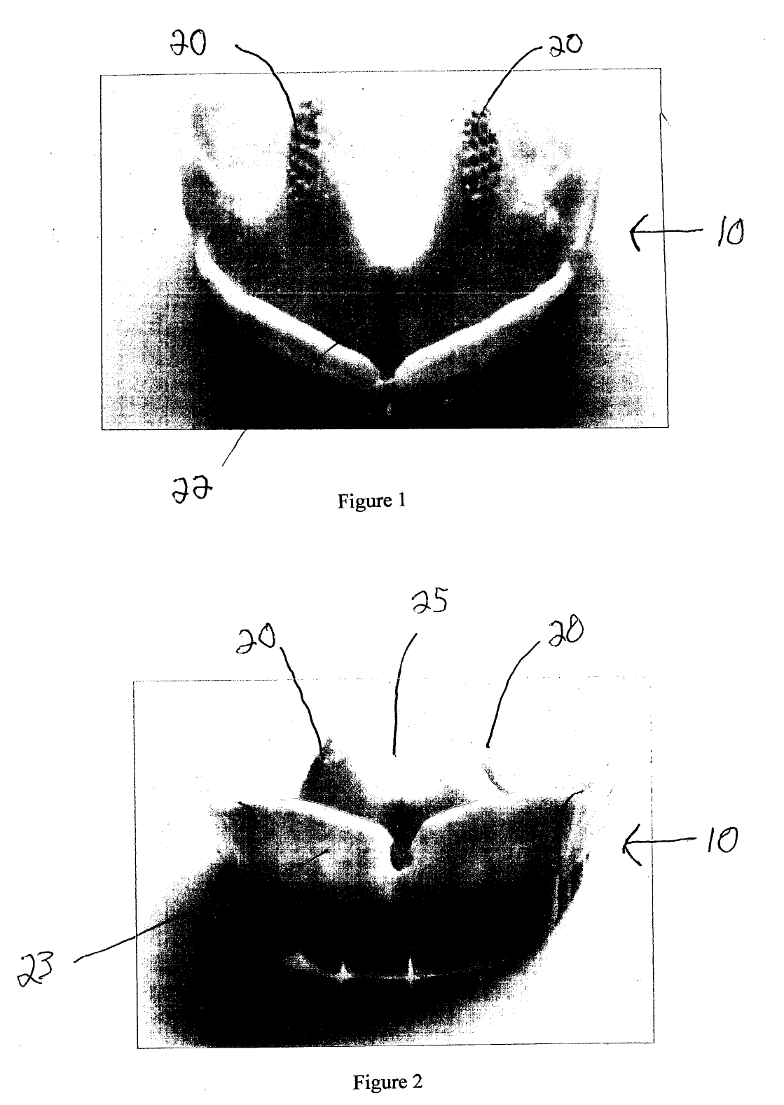

FIG. 2 shows a front view of the denture 10. The holes 20 can be made when the denture material is formed or they can be formed with a drilling tool. The additional adhesion from the holes 20 allows the labial flange 23 to be removed. Removal of the labial flange 23 gives the denture a more natural appearance then the denture wearer smiles. Roof area 25 of the denture can be removed to make a roofless denture that allows for better taste of food and better feel for texture of food.

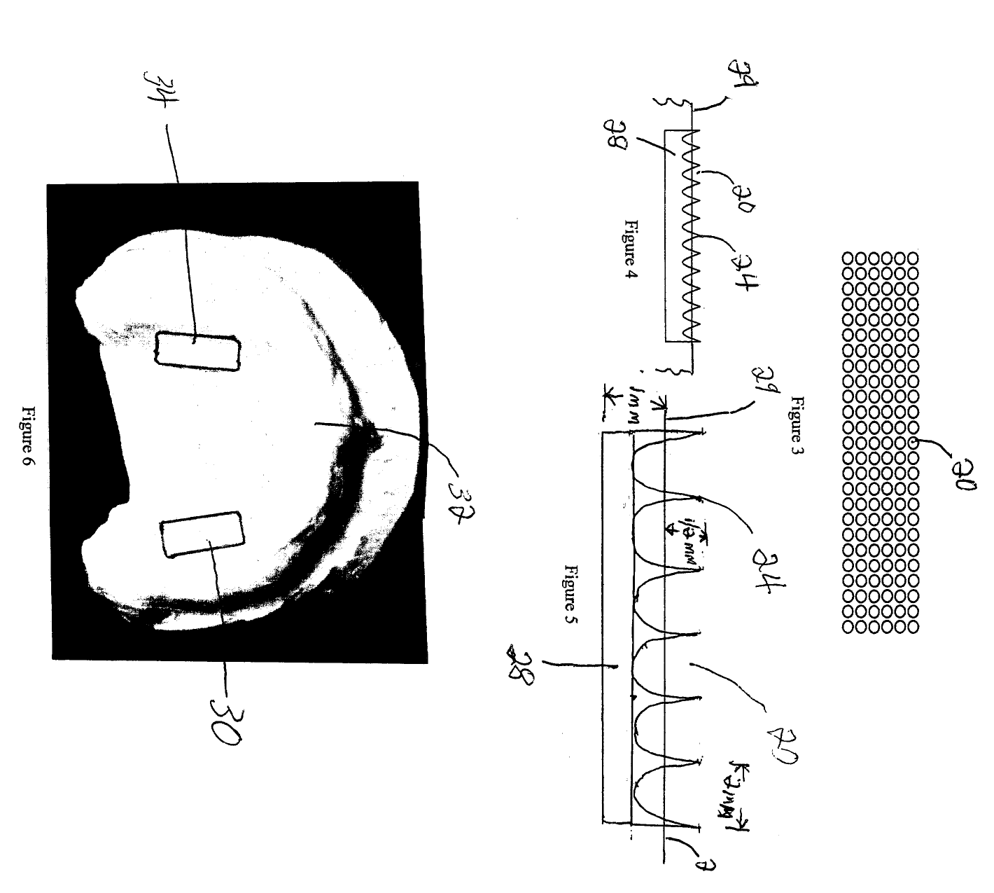

FIG. 3 shows a top view of this section holes 20. The holes themselves are approximately 1 mm deep and 2 mm across. The holes in conjunction with a dental adhesive increase the retentive force of the denture. These holes can create suction without the dental adhesive however the holes are more effective when a dental adhesive is used.

FIGS. 4 and 5 show side view of the suction holes. The ridges 24 can slightly penetrate (approximately ½ mm) the soft tissue area on the roof of the mouth to create suction. As stated before, a dental adhesive can be used to increase the suction created by contact between the soft tissue on the roof of the mouth and the ridges 24 of the suction holes 20. There is a remaining wall thickness 28 of approximately ½ mm at the base of the suction holes 20. The ridges 24 protrude ½ mm from the roof surface 29 of the denture 10 for penetration into the soft tissue of the roof of the mouth.

FIG. 6 shows a picture of the roof of the mouth. The areas 30, 32 and 34 correspond to the potential locations of soft tissue in the roof of the mouth. These areas of soft tissue can very by the amount of soft tissue and its location. Typically, a dentist who is fitting a patient with a denture would locate that patients soft tissue areas and then would fabricate the suction holes so that they would correspond to the areas of soft tissue.

For a patient with an existing denture, the dentist would locate the soft tissue areas and then would cut out a portion of the existing denture, without cutting all the way through the denture, leaving approximately ½ mm remaining wall thickness. The dentist would then add a strip of suction holes to the cutout portion of denture so that the suction holes would protrude approximately ½ mm from the roof surface of the denture and would correspond in location to the soft tissue areas on the roof of the mouth. If the denture had U-shaped channel in front, then it could be removed to give a more natural appearance. The added adhesion from the suction holes would make up for the loss of adhesion by elimination of the front portion of the U-shaped channel of the existing denture. The material used to make the holes is methalpolymetha crylate or acrylic resin. The holes 20 can be formed in strips that are 10-20 mm in length and 5-10 mm in width. The approximate effective range for the hole diameter is from ½ mm to approximately 3½ mm.

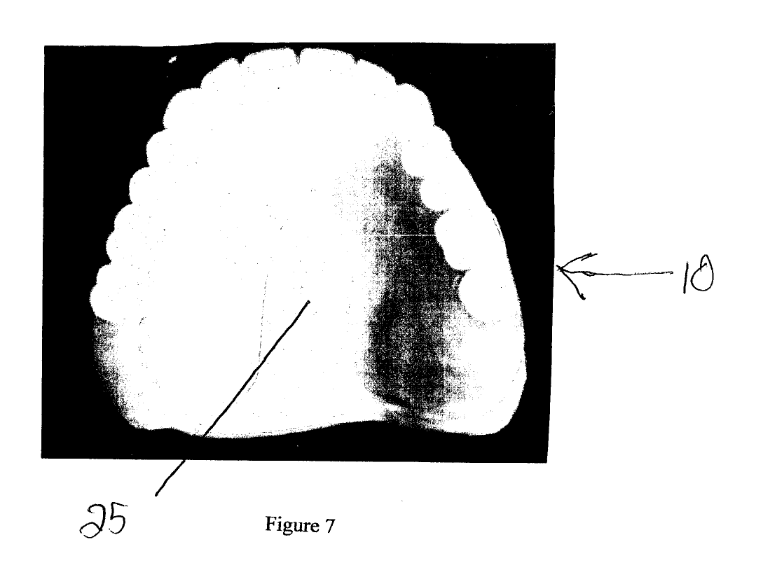

FIG. 7 is a picture showing the roofless denture 10 attached to a model of the roof of the mouth. The additional adhesion from the holes 20 (not shown) allows area 25 of the denture to be removed for improved taste and feel for the consistence of food.

While the dentures of the present invention are shown with reference to FIGS. 1 through 7, the instant invention is not limited to the exact embodiments shown herein, for obvious modifications can be made by a person skilled in the art.

What is claimed is:

1. A denture having suction holes located in an area corresponding to the soft tissue area of the roof of the mouth.

2. The denture of claim 1 wherein,
wherein said denture has a roof, and
wherein said denture has a portion of the roof of the denture removed.

3. The denture of claim 1 wherein,
wherein said denture has a labial flange, and
wherein said denture has a portion of the labial flange of the denture removed.

4. The denture of claim 1 wherein,
wherein said denture has a labial flange and a roof,
said denture has a portion of the roof of the denture removed, and,
wherein said denture has a portion of the labial flange of the denture removed.

5. A method of retrofitting a denture having the steps,
removing a portion of the denture corresponding to the soft tissue area of the denture wearer, and
adding suction holes to the portion of the denture that corresponds to the soft tissue area of the denture wearer.

6. The method of claim 5 including the steps of,
removing a portion of the labial flange of said denture.

7. The method of claim 5 including the steps of,
removing a portion of the roof of said denture.

8. The method of claim 5 including the steps of,
removing a portion of the labial flange of said denture, and
removing a portion of the roof of said denture.
